(19) United States
(12) Patent Application Publication
(10) Pub. No.: US 2023/0272167 A1
(43) Pub. Date: Aug. 31, 2023

(54) SILICONE SEALANT PREPARATION

(71) Applicant: DOW SILICONES CORPORATION, Midland, MI (US)

(72) Inventors: Aaron SEITZ, Midland, MI (US); Michael H. WANG, Midland, MI (US); Phil WILSON, Elizabethtown, KY (US)

(21) Appl. No.: 18/023,709

(22) PCT Filed: Jun. 28, 2021
(86) PCT No.: PCT/US2021/039298

§ 371 Date: Feb. 27, 2023

Related U.S. Application Data
(60) Provisional application No. 63/072,255, filed on Aug. 31, 2020.

(51) Int. Cl. C08G 77/18; C08K 3/36

(52) U.S. Cl. CPC C08G 77/18; C08K 3/36

(57) ABSTRACT

A process for the preparation of a one-component alkoxy-functional room temperature vulcanisable (RTV) composition, cured with a tin-based catalyst, is provided. The RTV composition is useful as a silicone sealant composition. The silicone sealant composition is designed for compositions comprising an alkoxy end-capped polydiorganosiloxane polymer, filler, a cross-linker and a tin-based catalyst. The process is designed to enable in-situ treatment of fillers, while seeking to reduce the presence of —OH group scavengers in the silicone sealant composition, especially during storage.

A process for the preparation of a one-component alkoxy-functional room temperature vulcanisable (RTV) composition, cured with a tin-based catalyst, is provided. The silicone sealant composition is designed for compositions comprising an alkoxy end-capped polydiorganosiloxane polymer, filler, a cross-linker and a tin-based catalyst and the process is designed to enable in-situ treatment of fillers whilst minimising the presence of —OH group scavengers in the composition.

It is known in the art to render one-component alkoxy-functional room temperature vulcanisable (RTV) compositions, cured with a tin-based catalyst, shelf-stable by incorporating a scavenger in the composition. Typically, the scavenger is either a separate compound or part of an alkoxy-functional cross-linking agent, which functions by absorbing all unbound or free hydroxy (—OH) groups in the composition so as to prevent the hydroxy groups from degrading and cross-linking the polymer mixture, thus deleteriously affecting its shelf life and curing properties, i.e. the reaction will continue to happen via remaining hydroxy groups which have not been end-capped or free hydroxy groups and viscosity will increase due to cross-linking.

The hydroxy radicals which can be removed by the scavenger can be found in materials normally present in the one-part, silicone sealant composition, for example, trace amounts of water, alcohols e.g. methanol, silanol radicals on silica filler (if used) and/or silanol containing polymers.

A variety of compounds have been proposed as scavengers useful for eliminating chemically combined hydroxy radicals. These include suitable silanes and silazanes. Examples of suitable silanes which might be used include, for the sake of example, those of the formula,

(R¹O)_{(4-a-b)}—Si(R²)_{b}(X)ₐ

where R is a C₍₁₋₁₃₎ monovalent substituted or unsubstituted hydrocarbon radical, which is preferably methyl, or a mixture of a major amount of methyl and a minor amount of phenyl, cyanoethyl, trifluoropropyl, vinyl, and mixtures thereof; R¹ is a C₍₁₋₈₎ aliphatic organic radical selected from alkyl radicals, alkyl ether radicals, alkyl ester radicals, alkyl ketone radicals, alkylsilane radicals or a C₍₇₋₁₃₎ aralkyl radical;
R² is a C₍₁₋₁₃₎ monovalent substituted or unsubstituted hydrocarbon radical, which is preferably methyl, or a mixture of a major amount of methyl and a minor amount of phenyl, cyanoethyl, trifluoropropyl, vinyl, and mixtures thereof; X is a hydrolyzable leaving group selected from amido, amino. carbamato, enoxy, imidato, isocyanato, oximato, thioisocyanato, and ureido radicals. The preferred groups are amino, amido, enoxy, a is an integer equal to 1 or 2, b is a whole number equal to 0 or 1 and the sum of a+b is equal to 1 or 2. The leaving group X reacts, preferentially before —OR¹, with available —OH groups in the one-part, silicone sealant composition and provides a composition substantially free of halogen acid, or carboxylic acid. This scavenger may also function as a polyalkoxysilane cross-linking agent for terminating the silicon atom at each organopolysiloxane chain-end with at least two alkoxy radicals. Suitable silazanes include for example hexamethyldisilazane.

One problem which is enhanced in the absence of the aforementioned scavengers is known in the art as “reversion”. Reversion may be identified pre-cure and post cure. In the case of pre-cure reversion, the sealant composition is destabilized in the presence of tin-based catalysts whereby the sealant composition undergoes a significant decrease in viscosity during storage due to scission of the polymer molecules. Post cure reversion is also a well-known issue in compositions containing tin-based catalysts whereby elastomers produced by tin cured systems as described herein, if heated immediately or shortly after having been cured, undergo post cure reversion. During this heating period, the elastomers liquefy or soften internally, although most of the time they remain solid on their external surfaces; nevertheless, the relatively thin surface layer which remains under these conditions is frequently sticky. This “reversion” can be produced at temperatures above 80° C. However, in the majority of cases it is produced at temperatures above 100° C. and it is particularly marked when the elastomers are heated in the total or virtual absence of air, that is to say, when the heated elastomers are in a partly or wholly closed system when being heated.

Furthermore, it is preferred for fillers e.g. silica fillers used in compositions of this sort to be hydrophobically treated so that they are more easily mixed with silicone polymers. Fillers may be pre-treated or alternatively are treated in-situ but for compositions of this type they are often pre-treated, which adds significant expense. Untreated silica fillers are naturally hydrophilic and have far more —OH groups at their surface than pre-treated silica fillers. Hence, compositions of this type, where the silica fillers are treated in-situ, require significantly more scavenger than if fillers are pre-treated in order to deal with the high levels of e.g. alcoholic byproducts resulting from the in-situ treatment of the untreated silica. Compositions of this type having untreated silica as a starting material are therefore far more difficult to make shelf stable which is why historically the far more expensive pre-treated fillers have been utilised in such compositions which, whilst requiring lesser amounts of scavenger in compositions, make the process prohibitively expensive to run.

The scavengers herein are particularly useful with respect to the pre-cure issues. A variety of processes incorporating the addition of such scavengers have been proposed in the prior art but have not been successful or require high levels of scavengers. This is because of the process steps involved and the order in which the process steps take place and/or because the use of the scavengers results in the presence of VOCs once the scavenger has reacted with the —OH groups mentioned above. It has been identified herein that the amount of the scavenger(s) needed can be significantly reduced when using the following process to prepare a one-part, silicone sealant composition comprising an alkoxy end-capped polydiorganosiloxane polymer, a cross-linker and a tin-based catalyst.

There is provided herein a process for making a one-part, silicone sealant composition comprising the steps of
(i) introducing an alkoxy end-capped polydiorganosiloxane polymer, a tin-based catalyst, a cross-linker, and optionally adhesion promoters in a mixer and mixing;
(ii) adding one or more reinforcing and optionally non-reinforcing fillers into the mixer and mixing so that residual chemically available —OH groups on the polymer and/or filler are able to undergo a condensation reaction with said cross-linker and/or optional adhesion promoter to generate alcoholic byproducts;
(iii) applying a vacuum to remove said alcoholic byproducts at a predetermined a controlled temperature of between 50° C. and 100° C.;
(iv) optionally cooling the resulting composition; and
(v) introducing a scavenger in an amount of from 0.5-3.0 wt. % of the composition.

The process herein may be completed using any sort of mixer e.g. a batch mixer or a twin-screw extruder. It was found that by undertaking the present process it became far easier to use untreated fumed silica fillers at step (ii) of the process and to treat them in-situ using the current process. This has significant cost benefits over the use of pre-treated silica fillers used previously. It was found that by mixing alkoxy end-capped polydiorganosiloxane polymer, cross-linker, and adhesion promoters (if required) with the tin-based catalyst for the one-part, silicone sealant composition in a first stage of the process, the tin-based catalyst initiated the reaction of cross-linkers and adhesion promoters (if present) with chemically available residual —OH groups on the polymer and subsequently with chemically available —OH groups on the filler surface as soon as they are introduced into the mixture. This means that resulting alcoholic byproducts, such as methanol and/or ethanol or the like, are generated early in the mixing process and may therefore be extracted during a devolatisation step during the mixing of the one-part, silicone sealant composition. As a consequence, this significantly reduces the level of alcoholic byproducts generated in the one-part, silicone sealant composition during storage prior to use, hence negating or minimising the need for stabilizer during storage because of the extraction of the alcoholic byproducts during mixing and prior to storage.

Hence, the present process requires far less scavenger than would have been previously anticipated when preparing a composition using untreated silica as a starting material because of the early inclusion of cross-linker/treating agent and adhesion promoter along with the catalyst and this appears to have substantially negated the stability issues previously encountered and requires significantly less scavenger to be used despite the in-situ treatment.

This new process therefore enables the treatment of untreated silica fillers in situ without the need of significant levels of alcohol scavenger because of the early devolatisation of the composition prior to the introduction of scavenger. This appears to be due to the early introduction of the tin-based catalyst into the mixer e.g. an extruder. Historically the catalyst has usually been added subsequent to or simultaneous with the scavenger whilst in the current process we are deliberately seeking to generate a large proportion of the alcoholic byproducts early in the process so that as much as possible of the alcoholic byproducts may be removed before introduction of the scavenger. Therefore, a main benefit of this process is the ability to utilise untreated silica fillers in a continuous process and to treat them in situ without a significant increase in the presence of scavengers being required to keep the composition stable during storage.

This is a significant improvement over previous processes where cure catalyst is typically one of the last ingredients introduced into the composition resulting in the potential production of alcoholic byproducts during storage which creates a need for sufficient scavenger presence for the removal of free alcohols (and other species with —OH groups) during storage. The alcoholic byproducts generated during storage or during the mixing process have been previously known to cause stability issues for the sealant composition as they interact with tin-based catalyst and the alkoxy end-capped silicone polymers to cause composition destabilization in the form of a pre-cure reversion whereby the sealant composition has a significant decrease in viscosity during storage due to scission of the polymer molecules. The latter is an issue particularly prevalent to silicone sealant compositions comprising alkoxy end capped polydiorganosiloxanes and tin-based catalysts as described herein.

The term “stable” as defined herein, with respect to a moisture curable mixture or composition, means the mixture/composition is capable of remaining substantially unchanged while excluded from atmospheric moisture and cures to a tack-free elastomer after an extended shelf period. By being “unchanged” it is meant that the composition does not deteriorate chemically while excluded from atmospheric moisture such that tack-free time exhibited by a curing composition within a short time after mixing e.g. less than or equal to 1 hour is substantially the same as that exhibited by the same composition curing after having been held in a moisture resistant and moisture-free container for an extended shelf period at ambient conditions, or an equivalent period based on accelerated aging at an elevated temperature and wherein the post cure physical properties of the resulting elastomer, e.g. shore A durometer, tensile strength and elongation have similar values.

A one-part, silicone sealant composition prepared in accordance with the above process comprises the following ingredients
(a) an alkoxy end-capped, polydiorganosiloxane polymer;
(b) reinforcing filler;
(c) cross-linker;
(d) a tin-based catalyst; and optionally
(e) adhesion promoter.
   Scavenger is provided to remove unwanted byproducts to stabilise the composition in storage. Where possible the reaction product of the scavenger/alcohol or other —OH containing by-product is removed prior to storage.

Any suitable alkoxy end-capped polydiorganosiloxane polymer (a) may be utilised for this process. For example, the alkoxy end-capped polydiorganosiloxane polymer (a) may have one of the following structures

(R^{x}O)₃₋ₙRₙSi—O—(R_{y}SiO_{(4-y)/2})_{z}—Si—Rₙ(OR^{x})₃₋ₙ or

(R^{x}O)₃₋ₙRₙSi—O—SiR₂—Z—(R_{y}SiO_{(4-y)/2})_{z}—SiR₂—Z—SiR₂—O—Si—Rₙ(OR^{x})₃₋ₙ

in which each R is an alkyl, alkenyl or aryl group, each R^{x} is an alkyl group and Z is a divalent organic group;
n is 0, 1 or 2, y is 0, 1 or 2, and z is an integer such that said organopolysiloxane polymer starting material has a viscosity of from 1,000 to 100,000 mPa·s at 25° C., alternatively from 5,000 to 90,000mPa·s at 25° C., using a Brookfield® rotational viscometer with spindle LV-4 (designed for viscosities in the range between 1,000-2,000,000 mPa·s) and adapting the speed (shear rate) according to the polymer viscosity. Given the above viscosity ranges z is therefore an integer enabling such a viscosity, alternatively z is an integer from 200 to 5000.

Each R is individually selected from alkyl groups, alternatively alkyl groups having from 1 to 10 carbon atoms, alternatively from 1 to 6 carbon atoms, alternatively 1 to 4 carbon atoms, alternatively methyl or ethyl groups; alkenyl groups alternatively alkenyl groups having from 2 to 10 carbon atoms, alternatively from 2 to 6 carbon atoms such as vinyl, allyl and hexenyl groups; aromatic groups, alternatively aromatic groups having from 6 to 20 carbon atoms, substituted aliphatic organic groups such as 3,3,3-trifluoropropyl groups aminoalkyl groups, polyaminoalkyl groups, and/or epoxyalkyl groups.

Each R^{x} is individually selected from alkyl groups, alternatively alkyl groups having from 1 to 10 carbon atoms, alternatively from 1 to 6 carbon atoms, alternatively 1 to 4 carbon atoms, alternatively methyl or ethyl groups;

Each Z is independently selected from an alkylene group having from 1 to 10 carbon atoms. In one alternative each Z is independently selected from an alkylene group having from 2 to 6 carbon atoms; in a further alternative each Z is independently selected from an alkylene group having from 2 to 4 carbon atoms. Each alkylene group may for example be individually selected from an ethylene, propylene, butylene, pentylene and/or hexylene group.

The alkoxy end-capped polydiorganosiloxane polymer can be a single polydiorganosiloxane polymer or it can be mixtures of polydiorganosiloxane polymers represented by the aforesaid formulae. Hence, the term “siloxane polymer mixture” in respect to the alkoxy end-capped polydiorganosiloxane polymer is meant to include any individual polydiorganosiloxane polymer starting material or mixtures of polydiorganosiloxane polymer starting materials.

The Degree of Polymerization (DP), (i.e. in the above formula substantially z), is usually defined as the number of monomeric units in a macromolecule or polymer or oligomer molecule of silicone. Synthetic polymers invariably consist of a mixture of macromolecular species with different degrees of polymerization and therefore of different molecular weights. There are different types of average polymer molecular weight, which can be measured in different experiments. The two most important are the number average molecular weight (Mn) and the weight average molecular weight (Mw). The Mn and Mw of a silicone polymer can be determined by Gel permeation chromatography (GPC) with precision of about 10-15%. This technique is standard and yields Mw, Mn and polydispersity index (PI). The degree of polymerisation (DP)=Mn/Mu where Mn is the number-average molecular weight coming from the GPC measurement and Mu is the molecular weight of a monomer unit. PI=Mw/Mn. The DP is linked to the viscosity of the polymer via Mw, the higher the DP, the higher the viscosity.

The alkoxy terminated polydiorganosiloxane (a), is typically present in the composition in an amount of from 40 to 80% by weight of the sealant composition, alternatively from about 40 to 55% by weight of the sealant composition.

Reinforcing filler (b) may contain one or more finely divided, reinforcing fillers such as precipitated calcium carbonate, ground calcium carbonate, fumed silica, colloidal silica and/or precipitated silica. Typically, the surface area of the reinforcing filler (b) is at least 15 m²/g in the case of precipitated calcium carbonate measured in accordance with the BET method in accordance with ISO 9277: 2010, alternatively 15 to 50 m²/g, alternatively, 15 to 25 m²/g in the case of precipitated calcium carbonate. Silica reinforcing fillers have a typical surface area of at least 50 m²/g. In one embodiment reinforcing filler (b) is a precipitated calcium carbonate, precipitated silica and/or fumed silica; alternatively, precipitated calcium carbonate. In the case of high surface area fumed silica and/or high surface area precipitated silica, these may have surface areas of from 75 to 400 m²/g measured using the BET method in accordance with ISO 9277: 2010, alternatively of from 100 to 300 m²/g using the BET method in accordance with ISO 9277: 2010.

Typically, the reinforcing fillers (b) are present in the composition in an amount of from about 5 to 45% by weight of the composition, alternatively from about 5 to 30% by weight of the composition, alternatively from about 5 to 25% by weight of the composition, depending on the chosen filler.

Reinforcing filler (b) is preferably hydrophobically treated in situ for example with one or more aliphatic acids, e.g. a fatty acid such as stearic acid or a fatty acid ester such as a stearate, or with organosilanes, organosiloxanes, or organosilazanes hexaalkyl disilazane or short chain siloxane diols to render the filler(s) (b) hydrophobic and therefore easier to handle and obtain a homogeneous mixture with the other adhesive components. The surface treatment of the fillers makes them easily wetted by alkoxy end-capped polydiorganosiloxane polymer (a). These surface modified fillers do not clump and can be homogeneously incorporated into the alkoxy end-capped polydiorganosiloxane polymer (a). This results in improved room temperature mechanical properties of the uncured compositions. The fillers may be pre-treated or may be treated in situ when being mixed with alkoxy end-capped polydiorganosiloxane polymer (a). In the present disclosure whilst the process functions with pre-treated fillers it is believed one of its main advantages is the ability to have a continuous process using previously untreated filler which is treated in-situ during the process whilst avoiding the necessity for high levels of scavenger to maintain the stability of the composition in storage.

Cross-linker (c) may be any suitable cross-linker having at least three groups per molecule which are reactable with the hydroxyl or hydrolysable groups of alkoxy end-capped polydiorganosiloxane polymer (a). It may be introduced into the mixer e.g. an extruder, individually or in a mixture with alkoxy end-capped polydiorganosiloxane polymer (a), discussed further below. Typically, cross-linker (c) is one or more silanes or siloxanes which contain silicon bonded hydrolysable groups such as acyloxy groups (for example, acetoxy, octanoyloxy, and benzoyloxy groups); ketoximino groups (for example dimethyl ketoximo, and isobutylketoximino); alkoxy groups (for example methoxy, ethoxy, iso-butoxy and propoxy) and alkenyloxy groups (for example isopropenyloxy and 1-ethyl-2-methylvinyloxy).

In the case of siloxane based cross-linkers the molecular structure can be straight chained, branched, or cyclic.

Cross-linker (c) preferably has at least three or four hydroxyl and/or hydrolysable groups per molecule which are reactive with the hydroxyl and/or hydrolysable groups in alkoxy end-capped polydiorganosiloxane polymer (a). When cross-linker (c) is a silane and when the silane has a total of three silicon-bonded hydroxyl and/or hydrolysable groups per molecule, the fourth group is suitably a non-hydrolysable silicon-bonded organic group. These silicon-bonded organic groups are suitably hydrocarbyl groups which are optionally substituted by halogen such as fluorine and chlorine. Examples of such fourth groups include alkyl groups (for example methyl, ethyl, propyl, and butyl); cycloalkyl groups (for example cyclopentyl and cyclohexyl); alkenyl groups (for example vinyl and allyl); aryl groups (for example phenyl, and tolyl); aralkyl groups (for example 2-phenylethyl) and groups obtained by replacing all or part of the hydrogen in the preceding organic groups with halogen. Preferably however, the fourth silicon-bonded organic groups are methyl groups.

Silanes and siloxanes which can be used as cross-linker (c) include alkyltrialkoxysilanes such as methyltrimethoxysilane (MTM) and methyltriethoxysilane, alkenyltrialkoxy silanes such as vinyltrimethoxysilane and vinyltriethoxysilane, isobutyltrimethoxysilane (iBTM). Other suitable silanes include ethyltrimethoxysilane, vinyltriethoxysilane, phenyltrimethoxysilane, alkoxytrioximosilane, alkenyltrioximosilane, 3,3,3-trifluoropropyltrimethoxysilane, methyltriacetoxysilane, vinyltriacetoxysilane, ethyl triacetoxysilane, di-butoxy diacetoxysilane, phenyl-tripropionoxysilane, methyltris(methylethylketoximo)silane, vinyl-tris-methylethylketoximo)silane, methyltris(methylethylketoximino)silane, methyltris(isopropenoxy)silane, vinyltris(isopropenoxy)silane, ethylpolysilicate, n-propylorthosilicate, ethylorthosilicate and/or dimethyltetraacetoxydisiloxane. Cross-linker (c) may alternatively comprise any combination of two or more of the above.

Alternatively, cross-linker (c) may comprise a silyl functional molecule containing two or more silyl groups, each silyl group containing at least one —OH or hydrolysable group, the total of number of —OH groups and/or hydrolysable groups per cross-linker molecule being at least 3. Hence, a disilyl functional molecule comprises two silicon atoms each having at least one hydrolysable group, where the silicon atoms are separated by an organic or siloxane spacer. Typically, the silyl groups on the disilyl functional molecule may be terminal groups. The spacer may be a polymeric chain having a siloxane or organic polymeric backbone. In the case of such siloxane or organic based cross-linkers (ii) the molecular structure can be straight chained, branched, cyclic or macromolecular. In the case of siloxane-based polymers the viscosity of the cross-linker (c) will be within the range of from 15 mPa·s to 80,000 mPa·s at 25° C. measured using a Brookfield® rotational viscometer with spindle LV-1 (designed for viscosities in the range between 15 -20,000 mPa·s) or with spindle LV-4 (designed for viscosities in the range between 1,000-2,000,000 mPa·s and adapting the speed (shear rate) according to the polymer viscosity.

For example, cross-linker (c) may be a disilyl functional polymer, that is, a polymer containing two silyl groups. each having at least one hydrolysable group such as described by the formula

RₙSi(X)₃₋ₙ—Z⁴—Si(X)₃₋ₙRₙ

where each R, and n may be individually selected as hereinbefore described above. Z⁴ is an alkylene (divalent hydrocarbon group), alternatively an alkylene group having from 1 to 10 carbon atoms, or further alternatively 1 to 6 carbon atoms or a combination of said divalent hydrocarbon groups and divalent siloxane groups.

Each X group may be the same or different and can be a hydroxyl group or a condensable or hydrolyzable group. The term “hydrolyzable group” means any group attached to the silicon which is hydrolyzed by water at room temperature. The hydrolyzable group X includes groups of the formula —OT, where T is an alkyl group such as methyl, ethyl, isopropyl, octadecyl, an alkenyl group such as allyl, hexenyl, cyclic groups such as cyclohexyl, phenyl, benzyl, beta-phenylethyl; hydrocarbon ether groups, such as 2-methoxyethyl, 2-ethoxyisopropyl, 2-butoxyisobutyl, p-methoxyphenyl or —(CH₂CH₂O)₂CH₃. The most preferred X groups are hydroxyl groups or alkoxy groups. Illustrative alkoxy groups are methoxy, ethoxy, propoxy, isopropoxy, butoxy, isobutoxy, pentoxy, hexoxy octadecyloxy and 2-ethylhexoxy; dialkoxy groups, such as methoxymethoxy or ethoxymethoxy and alkoxyaryloxy, such as ethoxyphenoxy. The most preferred alkoxy groups are methoxy or ethoxy.

Preferred di-silyl functional polymer cross-linkers have n=0 or 1, X=OMe and Z⁴ being an alkylene group with 4 to 6 carbons.

Examples of disilyl polymeric cross-linkers with a silicone or organic polymer chain bearing alkoxy functional end groups include polydimethylsiloxanes having at least one trialkoxy terminal where the alkoxy group may be a methoxy or ethoxy group. Examples might include or 1,6-bis(trimethoxy silyl)hexane, hexamethoxydisiloxane, hexaethoxydisiloxane, hexa-n-propoxydisiloxane, hexa-n-butoxydisiloxane, octaethoxytrisiloxane, octa-n-butoxytrisiloxane and decaethoxy tetrasiloxane. In one embodiment the cross-linker may be one or more of vinyltrimethoxysilane, methyltrimethoxysilane and/or vinylmethyldimethoxysilane.

The amount of cross-linker present in the composition will depend upon the particular nature of the cross-linker (c) utilised and in particular, the molecular weight of the molecule selected. The compositions suitably contain cross-linker (c) in at least a stoichiometric amount as compared to alkoxy terminated polydiorganosiloxane (a) described above. The cross-linker is therefore typically present in the composition in an amount of from 0.1 to 5% by weight of the composition.

The one-part, silicone sealant composition also comprises a tin-based catalyst. Any suitable tin-based catalyst may be utilised. Said tin-based catalyst, may comprise one or more include tin triflates, organic tin metal catalysts such as triethyltin tartrate, tin octoate, tin oleate, tin naphthenate, butyltintri-2-ethylhexoate, tin butyrate, carbomethoxyphenyl tin trisuberate, isobutyltintriceroate, and diorganotin salts especially diorganotin dicarboxylate compounds such as dibutyltin dilaurate (DBTDL), dioctyl tin dilaurate (DOTDL), dimethyl tin dibutyrate, dibutyltin dimethoxide, dibutyltin diacetate (DBTDA). dimethyl tin bisneodecanoate, dibutyltin dibenzoate, stannous octoate, dibutyltin bis(2,4-pentanedionate, dimethyltin dineodecanoate (DMTDN) dioctyltin dineodecanoate (DOTDN) and dibutyltin dioctoate.

Catalyst (d) is typically present in the composition in an amount of from 0.25 to 4.0% by weight of the composition, alternatively from 0.25 to 3% by weight of the composition, alternatively from 0.3% to 2.5% by weight of the composition.

When present, component (e) is an adhesion promoter. Suitable adhesion promoters (e) may comprise alkoxysilanes of the formula R¹⁴ₕSi(OR¹⁵)₍₄₋ₕ₎, where subscript h is 1, 2, or 3, alternatively h is 3. Each R¹⁴ is independently a monovalent organofunctional group. R¹⁴ can be an epoxy functional group such as glycidoxypropyl or (epoxycyclohexyl)ethyl, an amino functional group such as aminoethylaminopropyl or aminopropyl, a methacryloxypropyl, a mercapto functional group such as mercaptopropyl or an unsaturated organic group. Each R¹⁵ is independently an unsubstituted, saturated hydrocarbon group of at least 1 carbon atom. R¹⁵ may have 1 to 4 carbon atoms, alternatively 1 to 2 carbon atoms. R¹⁵ is exemplified by methyl, ethyl, n-propyl, and iso- propyl.

Alternatively the adhesion promoter may be glycidoxypropyltrimethoxysilane or a multifunctional material obtained by reacting two or more of the above. For examples the reaction product of an alkylalkoxysilicone e.g. trimethoxymethylsilane; an aminoalkoxysilane, e.g. 3-aminopropyl trimethoxysilane and an epoxyalkoxysilane e.g. glycidoxypropyl trimethoxysilane; in a weight ratio of 0.1-6:0.1-5:1 respectively.

Examples of suitable adhesion promoters (e) may also include and molecules of the structure:

(R′O)₃Si(CH₂)_{g}N(H)—(CH₂)_{q}NH₂

in which each R′ may be the same or different and is an alkyl group containing from 1 to 10 carbon atoms, g is from 2 to 10 and q is from 2 to 10.

The one-part silicone sealant composition may comprise, when present, 0.01% to 2 wt. %, alternatively 0.05 to 2 wt. %, alternatively 0.1 to 1 wt. % of adhesion promoter based on the weight of the composition. Preferably, the speed of hydrolysis of the adhesion promoter should be lower than the speed of hydrolysis of the cross-linker in order to favour diffusion of the molecule towards the substrate rather than its incorporation in the product network.

Any suitable —OH (moisture/water/alcohol) scavenger may be used, for example orthoformic acid esters, molecular sieves, silazanes e.g. organosilazanes such as hexaalkyl disilazane, e.g. hexamethyldisilazane and/or one or more silanes of the structure

R²⁰ⱼSi(OR²¹)₄₋ⱼ

where each R²¹ may be the same or different and is an alkyl group containing at least 2 carbon atoms;
j is 1 or 0; and
R²⁰ is a silicon-bonded organic group selected from a substituted or unsubstituted straight or branched monovalent hydrocarbon group having at least 2 carbons, a cycloalkyl group, an aryl group, an aralkyl group or any one of the foregoing wherein at least one hydrogen atom bonded to carbon is substituted by a halogen atom, or an organic group having an epoxy group, a glycidyl group, an acyl group, a carboxyl group, an ester group, an amino group, an amide group, a (meth)acryl group, a mercapto group or an isocyanate group.

Other additives may be used if necessary. These may include rheology modifiers, stabilizers such as anti-oxidants, UV and/or light stabilizers, pigments, plasticisers and/or extenders (sometimes identified as processing aids) and fungicides and/or biocides and the like; It will be appreciated that some of the additives are included in more than one list of additives. Such additives would then have the ability to function in all the different ways referred to.

Rheology modifiers which may be incorporated in moisture curable compositions according to the invention include silicone organic co-polymers such as those described in EP0802233 based on polyols of polyethers or polyesters; waxes such as polyamide waxes, non-ionic surfactants selected from the group consisting of polyethylene glycol, polypropylene glycol, ethoxylated castor oil, oleic acid ethoxylate, alkylphenol ethoxylates, copolymers or ethylene oxide and propylene oxide, and silicone polyether copolymers; as well as silicone glycols. For some systems these rheology modifiers, particularly copolymers of ethylene oxide and propylene oxide, and silicone polyether copolymers, may enhance the adhesion to substrates, particularly plastic substrates.

Any suitable antioxidant(s) may be utilised, if deemed required. Examples may include: ethylene bis (oxyethylene) bis(3-tert-butyl-4-hydroxy-5(methylhydrocinnamate) 36443-68-2; tetrakis[methylene(3,5-di-tert-butyl-4-hydroxy hydrocinnamate)]methane 6683-19-8; octadecyl 3,5-di-tert-butyl-4-hydroxyhyrocinnamate 2082-79-3; N,N′ -hexamethylene-bis (3,5-di-tert-butyl-4-hydroxyhyrocinnamamide) 23128-74-7; 3,5-di-tert-butyl-4-hydroxyhydrocinnamic acid, C7-9 branched alkyl esters 125643-61-0; N-phenylbenzene amine, reaction products with 2,4,4-trimethylpentene 68411-46-1; e.g. anti-oxidants sold under the Irganox® name from BASF.

UV and/or light stabilizers may include, for the sake of example include benzotriazole, ultraviolet light absorbers and/or hindered amine light stabilizers (HALS) such as the TINUVIN® product line from Ciba Specialty Chemicals Inc.

Pigments are utilized to color the composition as required. Any suitable pigment may be utilized providing it is compatible with the composition. In two-part compositions pigments and/or colored (non-white) fillers, e.g. carbon black may be utilized in the catalyst package to color the end adhesive product. When present carbon black will function as both a non-reinforcing filler and colorant and is present in a range of from 1 to 30% by weight of the catalyst package composition, alternatively from 1 to 20% by weight of the catalyst package composition; alternatively, from 5 to 20% by weight of the catalyst package composition, alternatively, from 7.5 to 20% by weight of the catalyst composition. Plasticisers and/or extenders (sometimes identified as processing aids)

Any suitable plasticiser or extender may be used if desired. These may be any of the plasticisers or extenders identified in GB2445821, incorporated herein by reference. When used the plasticiser or extender may be added before, after or during the preparation of the polymer, However, it does not contribute to or participate in the polymerisation process.

Examples of plasticisers or extenders include silicon containing liquids such as hexamethyldisiloxane, octamethyltrisiloxane, and other short chain linear siloxanes such as octamethyltrisiloxane, decamethyltetrasiloxane, dodecamethylpentasiloxane, tetradecamethylhexasiloxane, hexadeamethylheptasiloxane, heptamethyl-3-{(trimethylsilyl)oxy)}trisiloxane, cyclic siloxanes such as hexamethylcyclotrisiloxane, octamethylcyclotetrasiloxane, decamethylcyclopentasiloxane, dodecamethylcyclohexasiloxane; further polydiorganosiloxanes, optionally including aryl functional siloxanes, having a viscosity of from 0.5 to 12,500 mPa·s, measured at 25° C.; using a Glass Capillary Viscometer (ASTM D-445, IP 71) for 0.5 to 5000 mPa·s (the 5000 mPa·s needs test at 100° C.). For 5000-12500 mPa·s, it will use Brookfield cone plate viscometer RV DIII with a cone plate CP-52 at 5 rpm (ASTM D4287).

Alternatively, the plasticisers or extenders may include organic liquids such as butyl acetate, alkanes, alcohols, ketones, esters, ethers, glycols, glycol ethers, hydrocarbons, hydrofluorocarbons or any other material which can dilute the composition without adversely affecting any of the component materials. Hydrocarbons include isododecane, isohexadecane, Isopar™ L (C11-C13), Isopar™ H (C11-C12), hydrogenated polydecene, mineral oil, especially hydrogenated mineral oil or white oil, liquid polyisobutene, isoparaffinic oil or petroleum jelly. Ethers and esters include isodecyl neopentanoate, neopentylglycol heptanoate, glycol distearate, dicaprylyl carbonate, diethylhexyl carbonate, propylene glycol n butyl ether, ethyl-3 ethoxypropionate, propylene glycol methyl ether acetate, tridecyl neopentanoate, propylene glycol methylether acetate (PGMEA), propylene glycol methylether (PGME), octyldodecyl neopentanoate, diisobutyl adipate, diisopropyl adipate, propylene glycol dicaprylate/dicaprate, and octyl palmitate. Additional organic diluents include fats, oils, fatty acids, and fatty alcohols. A mixture may also be used.

Biocides may additionally be utilized in the composition if required. It is intended that the term “biocides” includes bactericides, fungicides and algicides, and the like. Suitable examples of useful biocides, which may be utilized in compositions as described herein, include, for the sake of example:

Carbamates such as methyl-N-benzimidazol-2-ylcarbamate (carbendazim) and other suitable carbamates, 10,10′-oxybisphenoxarsine, 2-(4-thiazolyl)-benzimidazole, N-(fluorodichloromethylthio)phthalimide, diiodomethyl p-tolyl sulfone, if appropriate in combination with a UV stabilizer, such as 2,6-di(tert-butyl)-p-cresol, 3-iodo-2-propinyl butylcarbamate (IPBC), zinc 2-pyridinethiol 1-oxide, triazolyl compounds and isothiazolinones, such as 4,5-dichloro-2-(n-octyl)-4-isothiazolin-3-one (DCOIT), 2-(n-octyl)-4-isothiazolin-3-one (OIT) and n-butyl-1,2-benzisothiazolin-3-one (BBIT). Other biocides might include for example Zinc Pyridinethione, 1-(4-Chlorophenyl)-4,4-dimethyl-3-(1,2,4-triazol-1-ylmethyl)pentan-3-ol and/or 1-[[2-(2,4-dichlorophenyl)-4-propyl-1,3-dioxolan-2-yl]methyl]-1H-1,2,4-triazole.

The fungicide and/or biocide may suitably be present in an amount of from 0 to 0.3% by weight of the composition and may be present in an encapsulated form where required such as described in EP2106418.

The process herein may be completed using any sort of mixer e.g. a batch mixer or a twin-screw extruder.

In the case of using a twin-screw extruder based process, there is provided a twin screw extruder barrel having two screws and several entry ports for introducing components into the extruder and transporting mixtures of said components along the barrel through a series of zones before leaving the extruder via an exit port. In step (i) of the process described herein, alkoxy end-capped organopolysiloxane polymer, cross-linker, tin-based catalyst and any adhesion promoter, if required, are introduced into a first zone of the twin-screw extruder. They may be added individually and/or in one or more pre-mixtures. If a combination of two or more of said components/ingredients are pre-mixed prior to introduction onto the twin-screw extruder, this pre-mixing step may be undertaken, for the sake of example, in any suitable preliminary mixer, such as a batch mixer or a static mixer, as desired or deemed required. Each component or mixture of components is introduced into the twin screw extruder via an entry port in a first zone, zone 1 thereof. Once, introduced onto the twin screw extruder these components go through an initial mixing process to produce an initial mixture as they are transported towards an adjacent second zone, zone 2, in the twin screw extruder. The initial mixture is then transported to the second zone, zone 2, of the twin-screw extruder, immediately downstream of the first zone. In zone 2 filler is introduced into the initial mixture and mixed to form a filled mixture. As previously indicated the filler may or may not have been pre-treated before introduction on to the twin-screw extruder. However, the process is most beneficial if the filler is untreated before entry into the extruder and is treated in situ i.e. treated during processing through the twin-screw extruder. This means that the filler surface is initially covered in —OH groups which react with alkoxy groups from ingredients in the initial mixture to form alcoholic byproducts, particularly methanol and ethanol.

The filled mixture resulting from step (ii) is then transported downstream of the zone 2, whilst continuing to be mixed and may, if desired, pass through a third zone, zone 3, providing an air vent and then on to a fourth zone, zone 4, which contains a further entry port for an optional dilution step in which either additional alkoxy end-capped organopolysiloxane polymer and/or extender/plasticiser is introduced into the filled mixture to produce an optional diluted mixture.

The filled mixture or optionally the diluted mixture is then transported through a fifth zone, zone 5. Zone 5 is a devolatisation zone used for step (iii) of the process during which a vacuum is applied and is used to extract as much of the alcoholic by-product produced whilst being transported through zones one to four (1-4). This avoids one major issue with previous processes in that unused scavenger is not removed during the devolatisation process. It also enables the extraction of much of the alcoholic byproducts prior to the introduction of the scavenger in step (v). Hence, upon completing devolatisation of step (iii), the resulting devolatised mixture may optionally be cooled if desired in optional step (iv).

Subsequent to devolatisation of step (iii) and optional step (iv) the devolatised mixture enters a final, sixth zone, zone 6, in step (v) in which an alcohol scavenger e.g. hexamethyldisilazane is introduced to provide the final one-part, silicone sealant composition comprising the following ingredients:
(a) an alkoxy-functional polydiorganosiloxane polymer;
(b) reinforcing filler;
(c)cross-linker;
(d) a tin-based catalyst; and optionally
(e) adhesion promoter.
   Any residual scavenger present is utilised to extract any alcoholic byproduct created subsequently e.g. during storage.

The above composition is suitable as a room temperature curable (RTV) one-part, silicone sealant composition and may, if desired, be designed to form a product upon cure having a low modulus and/or which is non-staining in that plasticizers and/or extenders (sometime referred to as processing aids) do not leech out and stain neighbouring substrates such as concrete blocks or other building materials.

Typically if a low modulus sealant composition is desired, the polymer made by the process described herein may have been chain extended as discussed below so that the alkoxy end-capped polydiorganosiloxane polymer (a) is designed to be of a high molecular weight/chain length.

In one embodiment the above process is a continuous process. The continuous process may comprise the process as hereinbefore described, e.g. utilising the twin-screw extruder process as described above. However, the continuous process may also include one or more steps before the process described above and may also include one or more steps after the process described above.

For example, when the continuous process includes one or more pre-steps prior to the above, one of these may be the alkoxy end-capping of a silanol terminated polydiorganosiloxane, wherein a silanol terminated polydiorganosiloxane is end-capped using a di, tri or tetra alkoxy silane in the presence of a suitable catalyst.

Furthermore, the continuous process may include one or more steps after the above including for the sake of example the transfer of the silicone sealant composition to a packaging unit for introduction into storage means such as sealant tubes and or sealed sealant “sausages” of sealant composition or any other suitable packaging means.

When the process for the preparation of a one-part, silicone sealant composition as hereinbefore described is a continuous process involving a pre-step where a silanol terminated polymer is first alkoxy-end capped, the silane utilised as the alkoxy end-capping agent and the cross-linker (c) for the silicone sealant composition may be one and the same and as such an excess of alkoxy silane may be introduced during the end-capping process and the unreacted alkoxysilane from said end-capping pre-step may be utilised as the cross-linker for the silicone sealant composition and as such the cross-linker and alkoxy-end-capped polydiorganosiloxane may be mixed in step (i) of the process herein prior to the introduction of tin-based catalyst for the silicone sealant composition and the adhesion promoter when present. In the case of such an option the alkoxy end-capped polydiorganosiloxane polymer/cross-linker mixture, tin-based catalyst for the silicone sealant composition and adhesion promoter, if present, can be mixed together prior to entry onto the twin-screw extruder or may be added via three entry ports in the first zone of the twin-screw extruder and may be initially mixed in the first zone of the twin-screw extruder. However, if the alkoxy end-capping agent is exhausted in the end-capping reaction, or if the alkoxy end-capped polydiorganosiloxane polymer is isolated from the reaction mixture, or if additional cross-linker is required in addition to the remaining alkoxy end-capping agent in order for the one-part, silicone sealant composition to be prepared via the process described herein, cross-linker (c) or a proportion of cross-linker (c) may be introduced separately from the alkoxy end-capped polydiorganosiloxane polymer.

In the case of a pre-step involving the alkoxy end-capping of a silanol terminated polydiorganosiloxane, the silanol terminated polydiorganosiloxane starting material typically has at least two silanol groups per molecule has the formula

(HO)₃₋ₙRₙSi—(Z)_{d}—(O)_{q}—(R_{y}SiO_{(4-y)/2})_{z}—(SiR₂—Z)_{d}—Si—Rₙ(OH)₃₋ₙ (1)

in which, each R is an alkyl, alkenyl or aryl group, and Z is a divalent organic group; d is 0 or 1, q is 0 or 1 and d+q=1; n is 0, 1 or 2, y is 0, 1 or 2, and z is an integer such that said organopolysiloxane polymer starting material has a viscosity of from 1,000 to 100,000 mPa·s at 25° C., alternatively from 5,000 to 90,000 mPa·s at 25° C., using a Brookfield® rotational viscometer with spindle LV-4 (designed for viscosities in the range between 1,000-2,000,000 mPa·s) and adapting the speed (shear rate) according to the polymer viscosity.

Typically in the above d is 0, q is 1 and n is 1 or 2. In such a case the silanol terminated polydiorganosiloxane starting material has the following structure:

(OH)₃₋ₙRₙSi—O—(R_{y}SiO_{(4-y)/2})_{z}—Si—Rₙ(OH)₃₋ₙ

with R, y and z being as described above, the average value of y is about 2, i.e. the silanol terminated polymer is substantially (i.e. greater than (>) 90% linear, alternatively >97% linear).

Each R is individually selected from alkyl groups, alternatively alkyl groups having from 1 to 10 carbon atoms, alternatively from 1 to 6 carbon atoms, alternatively 1 to 4 carbon atoms, alternatively methyl or ethyl groups; alkenyl groups alternatively alkenyl groups having from 2 to 10 carbon atoms, alternatively from 2 to 6 carbon atoms such as vinyl, allyl and hexenyl groups; aromatic groups, alternatively aromatic groups having from 6 to 20 carbon atoms, substituted aliphatic organic groups such as 3,3,3-trifluoropropyl groups aminoalkyl groups, polyaminoalkyl groups, and/or epoxyalkyl groups.

Each Z is independently selected from an alkylene group having from 1 to 10 carbon atoms. In one alternative each Z is independently selected from an alkylene group having from 2 to 6 carbon atoms; in a further alternative each Z is independently selected from an alkylene group having from 2 to 4 carbon atoms. Each alkylene group may for example be individually selected from an ethylene, propylene, butylene, pentylene and/or hexylene group. However, as previously indicated in the present instance d is usually 0 (zero).

The silanol terminated polydiorganosiloxane starting material has a viscosity of from 1,000 to 100,000 mPa·s at 25° C., alternatively from 5,000 to 90,000 mPa·s at 25° C., using a Brookfield® rotational viscometer with spindle LV-4 (designed for viscosities in the range between 1,000-2,000,000 mPa·s) and adapting the speed (shear rate) according to the polymer viscosity, z is therefore an integer enabling such a viscosity, alternatively z is an integer from 300 to 5000.

The silanol terminated polydiorganosiloxane starting material can be a single siloxane represented by Formula (1) or it can be mixtures of polydiorganosiloxane polymers represented by the aforesaid formula. Hence, the term “siloxane polymer mixture” in respect to the silanol terminated polydiorganosiloxane starting material is meant to include any individual polydiorganosiloxane polymer starting material or mixtures of polydiorganosiloxane polymer starting materials.

The Degree of Polymerization (DP), (i.e. in the above formula substantially z), is usually defined as the number of monomeric units in a macromolecule or polymer or oligomer molecule of silicone. Synthetic polymers invariably consist of a mixture of macromolecular species with different degrees of polymerization and therefore of different molecular weights. There are different types of average polymer molecular weight, which can be measured in different experiments. The two most important are the number average molecular weight (Mn) and the weight average molecular weight (Mw). The Mn and Mw of a silicone polymer can be determined by Gel permeation chromatography (GPC) with precision of about 10-15%. This technique is standard and yields Mw, Mn and polydispersity index (PI). The degree of polymerisation (DP)=Mn/Mu where Mn is the number-average molecular weight coming from the GPC measurement and Mu is the molecular weight of a monomer unit. PI=Mw/Mn. The DP is linked to the viscosity of the polymer via Mw, the higher the DP, the higher the viscosity.

During the end-capping pre-step, the silanol terminated polydiorganosiloxane starting material described above is reacted with a one or more polyalkoxy silanes of the structure

(R²—O)_{(4-b)}—Si—R¹_{b}

where b is 0, 1 or 2, alternatively 0 or 1; R² is an alkyl group having from 1 to 15 carbons C, alternatively from 1 to 10 carbons, alternatively from 1 to 6 carbons and may be linear or branched, for example methyl, ethyl, propyl, n-butyl, t-butyl, pentyl and hexyl, alternatively methyl or ethyl, alternatively R² may be a methyl group. R¹ may be any suitable group i.e. a monovalent hydrocarbon radical such as R² which may be substituted or unsubstituted e.g. substituted by halogen such as fluorine and chlorine e.g. trifluoropropyl and/or perfluoropropyl; cycloalkyl groups (for example cyclopentyl and cyclohexyl); alkenyl groups (for example vinyl and allyl); aryl groups (for example phenyl, and tolyl); aralkyl groups (for example 2-phenylethyl) and groups obtained by replacing all or part of the hydrogen in the preceding organic groups with halogen. In one embodiment R¹ may be a vinyl, methyl or ethyl, group, alternatively a vinyl or methyl group alternatively a methyl group.

Typically the amount of polyalkoxy silane present in the starting ingredients for the end-capping reaction is determined so that there is at least an equimolar amount of polyalkoxy silane present relative to the amount of —OH groups on the polymer. Hence, the greater the viscosity/chain length of the polymer used as a starting material, typically the less —OH groups present in the polymer and consequently less polyalkoxy silane is required. Equally the opposite is correct i.e. the smaller the viscosity/chain length of the polymer used as a starting material, typically the greater the number of —OH groups present in the polymer starting material and consequently a greater amount of polyalkoxy silane is required. However, in some instances there is a preference to include a significant molar excess of polyalkoxy silane and the remaining unreacted polyalkoxy silane present at the end of the end-capping reaction is then utilised as the cross-linker in e.g. a one-part, silicone sealant composition as described herein. Hence, in one embodiment herein when the end-capping pre-step is part of the overall process preferably there is a molar excess of polyalkoxy silane with respect to —OH groups on the polymer being end-capped.

As a consequence the separate addition of a cross-linker (c) into said one-part, silicone sealant composition is, during the preparation of the said composition, optional, if the alkoxy end-capped polydiorganosiloxane polymer reaction product being utilised comprises as excess of poly alkoxy silane. This is because whilst an essential ingredient in said one-part organopolysiloxane elastomer composition, the cross-linker (c) may be the same as the one or more polyalkoxy silanes of the structure (R²—O)_{(4-b)}—Si—R¹_{b} used in the end-capping reaction described above, wherein R², R¹ and b are as described before. When this is the case it is possible for the polyalkoxy silanes to be introduced into the reaction mixture for end capping the silanol polymer in sufficient excess at the time of the end-capping reaction that no additional cross-linking agent (c) is required at the time of preparing the one-part organopolysiloxane elastomer composition. However, if deemed necessary additional cross-linker(s) may be added at the time of preparing the one-part organopolysiloxane elastomer composition.

The one-part silicone sealant composition suitably contains cross-linker (c) in at least a stoichiometric amount as compared to alkoxy terminated polydiorganosiloxane (a) described above, irrespective of whether it originates as an excess from the end-capping reaction or from addition thereof after completion of the end-capping reaction or a combination of the two.

Any suitable end-capping catalyst may be utilised to catalyse the aforementioned end-capping process. The suitable end-capping catalyst may include for the sake of example acids including Lewis acids, inorganic bases, amines, inorganic oxides, potassium acetate, titanium/amine combinations, carboxylic acid/amine combinations, alkoxyaluminium chelates, N,N′-Disubstituted hydroxylamines, carbamates. However, whilst having been proposed many of these are undesirable for a variety of reasons for example, amine catalyst systems are slow, particularly given the level of reactivity of many of the polyalkoxysilanes involved in the process. In addition, amine and carboxylic acid catalysts are corrosive and require special handling and removal processes once the reaction has proceeded to the desired state of completion. Lithium hydroxide, being an inorganic solid, requires a polar solvent such as methanol to introduce it as a solution into the reaction. However, the presence of methanol leads to a continual regeneration of the catalyst e.g. in the form of lithium methoxide and consequently, the resultant polymer product exhibits a rapid lowering of viscosity due to interaction with said regenerated lithium catalyst. Furthermore, many of these end-capping catalysts can release displeasing odours and are dangerous to eyes and skin, and their removal is often difficult, requiring extra steps which are laborious and costly. Hence, in a preferred embodiment the end-capping catalysts may consist of one or more linear, branched or cyclic molecules comprising at least one amidine group, guanidine group, or derivatives of said amidine group and/or guanidine group or a mixture thereof in an amount of from 0.0005 to 0.75 wt. % of the starting materials.

The preferred end-capping catalyst utilised in accordance with the disclosure herein is selected from one or more linear, branched or cyclic molecules comprising one or more groups selected from amidine groups, guanidine groups, derivatives of said amidine groups and/or guanidine groups or a mixture thereof.

The one or more linear, branched or cyclic molecules comprising one or more groups selected from amidine groups, guanidine groups, derivatives of said amidine groups and/or guanidine groups or a mixture thereof may comprise linear, branched or cyclic silicon containing molecules or linear, branched or cyclic organic molecules containing one or more of the groups (1) to (4) depicted below.

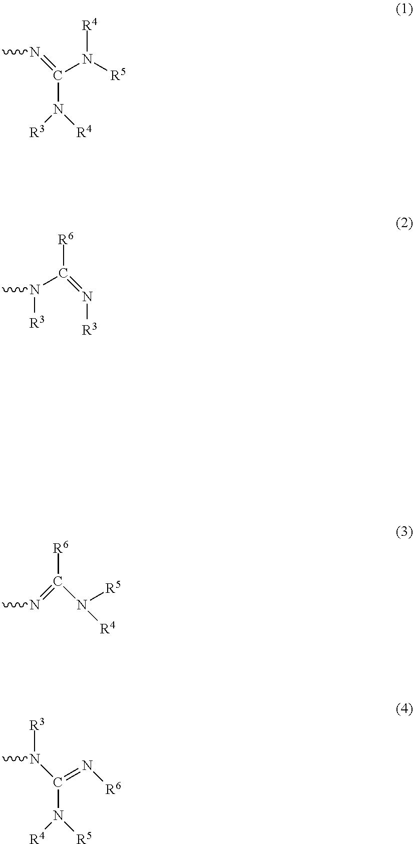

Wherein each R⁴, R⁵, R⁶, R⁷ and R⁸ may be the same or different and may be selected from hydrogen, an alkyl group, a cycloalkyl group, a phenyl group, an aralkyl group or alternatively R⁴ and R⁵ or R⁶ and R⁵ or R⁷ and R⁵ or R⁸ and R⁴ may optionally form ring structure, for example a heterogeneously substituted alkylene group to form a ring structure, wherein the heterogeneous substitution is by means of an oxygen or nitrogen atom.

In one embodiment formulas (1) to (4) may be part of a silane structure where the nitrogen is bonded to a silicon atom via an alkylene group, e.g.:

(R¹⁰)₃Si—Z—A

wherein Z is as hereinbefore described, each R¹⁰ may be the same or different and may be a hydroxyl and/or hydrolysable group (such as those described in relation to cross-linker (c) later in the description), an alkyl group; a cycloalkyl group; alkenyl group, aryl group or an aralkyl group; and A is one of (1) to (4) above.

In a further alternative any one of structures (1) to (4) above may be linked to a polymer radical selected from a group consisting of alkyd resins, oil-modified alkyd resins, saturated or unsaturated polyesters, natural oils, epoxides, polyamides, polycarbonates, polyethylenes, polypropylenes, polybutylenes, polystyrenes, ethylene-propylene copolymers, (meth)acrylates, (meth)acrylamides and salts thereof, phenolic resins, polyoxymethylene homopolymers and copolymers, polyurethanes, polysulphones, polysulphide rubbers, nitrocelluloses, vinyl butyrates, vinyl polymers, ethylcelluloses, cellulose acetates and/or butyrates, rayon, shellac, waxes, ethylene copolymers, organic rubbers, polysiloxanes, polyethersiloxanes, silicone resins, polyethers, polyetheresters and/or polyether carbonates. If structures (1) to (4) are linked to a siloxane radical they may be bonded to a polysiloxane radical having an average molecular weight in the range of from 206 to 50,000 g/mol, in particular 280 to 25,000 g/mol, particularly preferably 354 to 15,000 g/mol. A catalyst having such a polysiloxane radical is typically liquid at room temperature, has a low vapor pressure, is particularly readily compatible in curable compositions based on silicone polymers and in this context tends particularly little towards separation or migration.

For example, the end-capping catalyst may be 1,1,3,3-tetramethylguanidine (TMG) having the structure (CH₃)₂N—C═NH(N(CH₃)₂) or may be a silane of the following structure:

(R²—O)_{(4-a-b)}—Si—R³ₐR¹_{b}

where R², R¹ and b are as described above, a is 1 and R³ is —Z¹—N═C—(NR⁵R⁴)₂ in which R⁵ and R⁴ are as defined above, Z¹ is an alkylene or an oxyalkylene group having from 2 to 6 carbons and a is 1.
Specific examples include, 2-[3-(trimethoxysilyl)propyl]-1,1,3,3-tetramethylguanidine and 2-[3-(methyldimethoxysilyl)propyl]-1,1,3,3-tetramethylguanidine.

Alternatively, the end-capping catalyst may be a cyclic guanidine such as for example, Triazabicyclodecene (1,5,7-Triazabicyclo[4.4.0]dec-5-ene (TBD)) as depicted below:

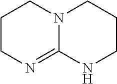

or 7-Methyl-1,5,7-triazabicyclo[4.4.0]dec-5-ene (mTBD) as depicted below

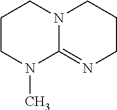

Alternatively, the end-capping catalyst may be a cyclic amidine such as for example,1,5-Diazabicyclo[4.3.0]non-5-ene (DBN) as depicted below

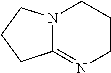

or 1,8-diazabicyclo[5.4.0]undec-7-ene (DBU) as depicted below

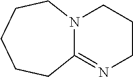 [SMILES: C1CCC2=NCCCN2CC1]

When the reaction can be continuously mixed (e.g., magnetic stir bar or overhead mechanical stirrer), the end-capping catalyst can be added directly as a solid. Furthermore, if the catalyst can be introduced into the reaction environment in the form of a fine powder a solvent is optional. If the reaction will be mixed and allowed to rest, then the catalyst is delivered as a solution to ensure homogenous dispersion. When delivered in solution the solvent may be a compatible silicone or organic solvent such as, for the sake of example, trimethyl terminated polydimethylsiloxane or toluene. However, to minimise VOC issues it was found that a preferable liquid for delivery of the end-capping catalyst was, in actual fact, the or one of the polyalkoxysilanes being utilised to end-cap the silanol-terminated polydiorganosiloxane starting material, for example vinyl trimethoxy silane and/or methyl trimethoxy silane.

Typically the end-capping process described above is carried out in the absence of other ingredients, however, if required additional ingredients which will not interfere with the end-capping process described herein such as plasticisers/extenders and or pigments may be present in the composition prior to the process, if desired. However, these are generally added during subsequent preparation of compositions utilising the alkoxy end-capped polydiorganosiloxane polymer provided by the process herein, as discussed later in the description.

When the above pre-step is undertaken it may comprise based on the weight of the starting materials:

(ai) silanol terminated polydiorganosiloxane starting material in an amount of from 40 wt. % to 99.5 wt. % of the ingredients, alternatively 60 to 99.5 wt. % of the starting materials, alternatively from 70 to 99.5 wt. % of the ingredients, alternatively from 80 to 99.5 wt. % of the starting materials alternatively from 90 to 99.5 wt. % of the starting materials, alternatively from 95 to 99.5 wt. % of the starting materials;
(aii) one or more polyalkoxy silanes of the structure

(R²—O)_{(4-b)}—Si—R¹_{b}

where b is 0, 1 or 2, R² is an alkyl group which may be linear or branched having from 1 to 15 carbons and R¹ may be any suitable group i.e. a monovalent hydrocarbon radical such as R², cycloalkyl groups; alkenyl groups, aryl groups; aralkyl groups and groups obtained by replacing all or part of the hydrogen in the preceding organic groups with halogen; in an amount of from about 0.5 to 60 wt. % of the starting materials, alternatively 0.5 to 40 wt. % of the starting materials, 0.5 to 30 wt. % of the starting materials, 0.5 to 20% of the starting materials, 0.5 to 10 wt. % of the ingredients, alternatively 0.5 to 5 wt. % of the ingredients, alternatively 0.25 to 2.5 wt. % of the starting materials,
and
(aiii) an end-capping catalyst consisting of one or more linear, branched or cyclic molecules comprising at least one amidine group, guanidine group, or derivatives of said amidine group and/or guanidine group or a mixture thereof in an amount of from 0.0005 to 0.75 wt. % of the starting materials. It will be appreciated that the total weight % (wt. %) of the starting ingredients is 100 wt. %.

Furthermore, if desired, prior to or even concurrently with the process hereinbefore described, chain extenders may be introduced to extend the length of the polymer chain prior to end-capping with the alkoxysilanes. The chain extenders, may, for the sake of example, be difunctional silanes. Suitable difunctional silanes may have the following structure

(R¹¹)₂—Si—(R¹²)₂

Wherein each R¹¹ may be the same or different and may be linear, branched or cyclic but is a non-functional group, in that it is unreactive with the —OH groups or hydrolysable groups of a silanol terminated polydiorganosiloxane . Hence, each R¹¹ group is selected from an alkyl group having from 1 to 10 carbon atoms, an alkenyl group, an alkynyl group or an aryl group such as phenyl. In one alternative the R¹¹ groups are either alkyl groups or alkenyl groups, alternatively there may be one alkyl group and one alkenyl group per molecule. The alkenyl group may for example be selected from a linear or branched alkenyl groups such as vinyl, propenyl and hexenyl groups and the alkyl group has from 1 to 10 carbon atoms, such as methyl, ethyl or isopropyl. In a further alternative R¹¹ may be replaced by R¹¹¹ which is cyclic and bonds to the Si atom in two places.

Each group R¹² may be the same or different and is reactable with the hydroxyl or hydrolysable groups. Examples of group R¹² include alkoxy, acetoxy, oxime, hydroxy and/or acetamide groups. Alternatively, each R¹² is either an alkoxy group or an acetamide group. When R¹² is an alkoxy group, said alkoxy groups containing between 1 and 10 carbon atoms, for example methoxy, ethoxy, propoxy, isoproproxy, butoxy, and t-butoxy groups. Specific examples of suitable silanes for component (c) herein include, alkenyl alkyl dialkoxysilanes such as vinyl methyl dimethoxysilane, vinyl ethyldimethoxysilane, vinyl methyldiethoxysilane, vinylethyldiethoxysilane, alkenylalkyldioximosilanes such as vinyl methyl dioximosilane, vinyl ethyldioximosilane, vinyl methyldioximosilane, vinylethyldioximosilane, alkenylalkyldiacetoxysilanes such as vinyl methyl diacetoxysilane, vinyl ethyldiacetoxysilane, vinyl methyldiacetoxysilane, vinylethyldiacetoxysilane and alkenylalkyldihydroxysilanes such as vinyl methyl dihydroxysilane, vinyl ethyldihydroxysilane, vinyl methyldihydroxysilane and vinylethyldihydroxysilane.

When R¹² is an acetamide the disilane may be a dialkyldiacetamidosilane or an alkylalkenyldiacetamidosilane. Such diacetamidosilanes are known chain extending materials for low modulus sealant formulations as described in for example U.S. Pat. Nos. 5,017,628 and 3,996,184.

When the process for preparing said one-part, silicone sealant composition is a continuous process involving a pre-step of alkoxy end-capping silanol terminated polydiorganosiloxane polymers, the initial end-capping process may take place in any suitable mixer e.g. a static mixer where the ingredients e.g. polymer alkoxy silane and end-capping catalyst are intermixed at a temperature of between room temperature (20 to 25° C.) and 100° C. In the case of the preferred end-capping process utilising amidine and/or guanidine compounds as the end-capping catalyst, is undertaken in the chosen reactor e.g. a static reactor and during transport to the twin-screw extruder or other mixer for a period of from 5 to 15 minutes, alternatively from 5 to 12 minutes, alternatively from 5 to 10 minutes. This period may also include the time during which the alkoxy end-capped polydiorganosiloxane polymer is mixed with the tin-based catalyst and adhesion promoter, when the latter is present.

In the event it is desired for the polymer to be chain extended, a chain extension process step is also undertaken. Typically in this case the chain-extender is added in a first step instead of the one or more polyalkoxy silanes and then after a chain-extension step, involving the catalyst as descried above is considered completed the polyalkoxy silanes are introduced into the mixture with the intention of end-capping the chain-extended polymer. The mixing may take place in any suitable type of mixer e.g. a speedmixer or Turello mixer. Alternatively, the chain extending silane and end-capping silane may be added simultaneously if the silanes are different. Alternatively, the chain extending silane and end-capping silane may be added separately if they are the same silane.

It is unnecessary to neutralise the alkoxy end-capped polydiorganosiloxane polymer end product, unlike in most prior art methodologies providing the alkoxy end-capped polydiorganosiloxane polymer is to be utilised within a period of no more than 7 to 10 days from production, although neutralisation may be undertaken if desired and this may extend the stability of the alkoxy end-capped polydiorganosiloxane polymer.

Furthermore, the continuous process may include one or more steps after the process described herein including for the sake of example the transfer of the one-part, silicone sealant composition produced as previously described to a packaging unit for introduction into storage means such as sealant tubes and or sealed sealant “sausages” of sealant composition or any other suitable packaging means.

In such a case, the outlet of the extruder may be connected to valves to direct materials coming out of the extruder to be directed to the appropriate storage tank and/or packaging unit. This may be actuated by a suitable control unit for actuating the valves to remove material if it does not meet the required composition and process condition specifications.

The packaging assembly may, for the sake of example include hoses, valves, dosing units, pigment feed systems, mixers, fixed or removable containers used to dispose of the silicone sealant composition being processed. Hoses include any type of hoses used in manufacturing silicone sealant composition. They may be of varying length, diameter as desired. Valves include any of those valves used in manufacturing equipment to direct flow of material towards one direction or alternate directions. Dosing units are any unit designed to accurately meter in the appropriate amount of the sealant composition and pigment into the container. Pigment feed systems include pumps and valves to deliver pigment to the packaging unit. Mixers include either static mixers or dynamic mixers suitable for mixing the sealant composition with pigment. Containers include tubes sausages, pails, drums, bottles, or any other suitable container for transportation and warehousing.

The temperature of the packaging assembly may range of from 20 to 100° C., alternatively of from 20 to 80° C., alternatively from 20 to 50° C. Typically these temperatures are largely dependent on the temperatures of the materials leaving the extruder.

The one-part, silicone sealant compositions prepared by the process described herein are preferably room temperature vulcanisable compositions in that they cure at room temperature without heating but may if deemed appropriate be accelerated by heating.

The one-part, silicone sealant compositions prepared by the process described herein may be designed to provide a low modulus and high extension sealant, adhesive and/or coating composition. Low modulus silicone sealant compositions are preferably “gunnable” i.e. they have a suitable extrusion capability i e a minimum extrusion rate of 10 ml/min as measured by ASTM C1183-04, alternatively 10 to 1000 mL/min, and alternatively 100 to 1000 mL/min.

The ingredients and their amounts in the one-part, silicone sealant compositions may be selected to impart a movement capability to the post-cured sealant material. The movement capability is greater than 25%, alternatively movement capability ranges from 25% to 50%, as measured by ASTM C719-13.

A one-part, silicone sealant composition prepared by the process described herein may be a gunnable sealant composition used for
(i) space/gap filling applications;
(ii) seal applications, such as sealing the edge of a lap joint in a construction membrane; or
(iii) seal penetration applications, e.g. sealing a vent in a construction membrane;
(iv) adhering at least two substrates together;
(v) a laminating layer between two substrates to produce a laminate of the first substrate, the sealant product and the second substrate.
   In the case of (v) above, when used as a layer in a laminate, the laminate structure produced is not limited to these three layers. Additional layers of cured sealant and substrate may be applied. The layer of gunnable sealant composition in the laminate may be continuous or discontinuous.

A one-part, silicone sealant composition prepared by the process described herein may be applied on to any suitable substrate. Suitable substrates may include, but are not limited to, glass; concrete; brick; stucco; metals, such as aluminium, copper, gold, nickel, silicon, silver, stainless steel alloys, and titanium; ceramic materials; plastics including engineered plastics such as epoxies, polycarbonates, poly(butylene terephthalate) resins, polyamide resins and blends thereof, such as blends of polyamide resins with syndiotactic polystyrene such as those commercially available from The Dow Chemical Company, of Midland, Mich., U.S.A., acrylonitrile-butadiene-styrenes, styrene-modified poly(phenylene oxides), poly(phenylene sulfides), vinyl esters, polyphthalamides, and polyimides; cellulosic substrates such as paper, fabric, and wood; and combinations thereof. When more than one substrate is used, there is no requirement for the substrates to be made of the same material. For example, it is possible to form a laminate of plastic and metal substrates or wood and plastic substrates.

In the case of one-part, silicone sealant compositions prepared by the process described herein, there is provided a method for filling a space between two substrates so as to create a seal therebetween, comprising:

a) providing a silicone composition as hereinbefore described, and either
b) applying the silicone composition to a first substrate, and bringing a second substrate in contact with the silicone composition that has been applied to the first substrate, or
c) filling a space formed by the arrangement of a first substrate and a second substrate with the silicone composition and curing the silicone composition.

In one alternative, a one-part, silicone sealant composition prepared by the process described herein may be a self-levelling sealant, e.g. a self-levelling highway sealant. A self-levelling sealant composition means it is “self-levelling” when extruded from a storage container into a horizontal joint; that is, the sealant will flow under the force of gravity sufficiently to provide intimate contact between the sealant and the sides of the joint space. This allows maximum adhesion of the sealant to the joint surface to take place. The self-levelling also does away with the necessity of tooling the sealant after it is placed into the joint, such as is required with a sealant which is designed for use in both horizontal and vertical joints. Hence, the sealant flow sufficiently well to fill a crack upon application. If the sealant has sufficient flow, under the force of gravity, it will form an intimate contact with the sides of the irregular crack walls and form a good bond; without the necessity of tooling the sealant after it is extruded into the crack, in order to mechanically force it into contact with the crack sidewalls.

Self-levelling compositions as described herein are useful as a sealant having the unique combination of properties required to function in the sealing of asphalt pavement. Asphalt paving material is used to form asphalt highways by building up an appreciable thickness of material, such as 20.32 cm, and for rehabilitating deteriorating concrete highways by overlaying with a layer of a thickness such as 10.16 cm. Asphalt overlays undergo a phenomenon known as reflection cracking in which cracks form in the asphalt overlay due to the movement of the underlying concrete at the joints present in the concrete. These reflection cracks need to be sealed to prevent the intrusion of water into the crack, which will cause further destruction of the asphalt pavement when the water freezes and expands.

In order to form an effective seal for cracks that are subjected to movement for any reason, such as thermal expansion and contraction, the seal material must bond to the interface at the sidewall of the crack and must not fail cohesively when the crack compresses and expands. In the case of the asphalt pavement, the sealant must not exert enough strain on the asphalt at the interface to cause the asphalt itself to fail; that is, the modulus of the sealant must be low enough that the stress applied at the bond line is well below the yield strength of the asphalt.

In such instances, the modulus of the cured material is designed to be low enough so that it does not exert sufficient force on the asphalt to cause the asphalt to fail cohesively. The cured material is such that when it is put under tension, the level of stress caused by the tension decreases with time so that the joint is not subjected to high stress levels, even if the elongation is severe.

Alternatively, the one-part, silicone sealant compositions prepared by the process described herein may be utilised as an elastomeric coating composition, e.g. as a barrier coating for construction materials or as a weatherproof coating for a roof, the composition may have a viscosity not dissimilar to a paint thereby enabling application by e.g. brush, roller or spray gun or the like. A coating composition as described herein, when applied onto a substrate, may be designed to provide the substrate with e.g. long-term protection from air and water infiltration, under normal movement situations caused by e.g. seasonal thermal expansion and/or contraction, ultra-violet light and the weather. Such a coating composition can maintain water protection properties even when exposed to sunlight, rain snow or temperature extremes.

### EXAMPLES

In a continuous process comprising the process as hereinbefore described which commenced with the optional pre-step of alkoxy end-capping, a silanol terminated polydiorganosiloxane for each example. In each example an alkoxy terminated siloxane polymer was initially prepared by way of a continuous in a static mixer by mixing:
(i) a dimethylsilanol terminated polydimethylsiloxane having a viscosity of 50,000 mPa·s at 25° C. and an average of 3.7 wt. % Si—OH groups per molecule in an amount of 96.87% by weight of the initial ingredients;
(ii) vinyl trimethoxy silane (VTM) in an amount of 1.90% by weight of the initial ingredients;
(iii) methyl trimethoxy silane (MTM) in an amount of 1.12% by weight of the initial ingredients;
(iv) a 2% solution of 1,5,7-Triazabicyclo[4.4.0]dec-5-ene (TBD) catalyst in MTM in an amount of 0.11% by weight of the initial ingredients.

An excess of cross-linker was provided in the above. There were seven times the number of moles of alkoxy silane (VTM and +MTM) per mole of OH on the dimethylsilanol terminated polydimethylsiloxane polymer in the alkoxy end-capping step. Because of this only about 15% of the cumulative molar amount of VTM and MTM introduced into the static mixer was utilised in the end-capping process. Hence, approximately 85% of the VTM and MTM silanes were present in the final product resulting from the end-capping process. untreated in the fed is required to react with all of the OH on the polymer, so 85% of the cross-linker is in excess (the total % of cross-linker fed is 3.13% (VTM 1.9%+1.12% MTM+0.108% MTM in TBD solution so the was an excess of approximately 2.65% by weight of the composition. The excess of VTM and MTM was therefore subsequently used as the cross-linker for the one-part, silicone sealant composition.

A twin-screw extruder having several zones was used to prepare the one-part, silicone sealant composition. In the first batch of examples the same amounts of all components were used with the exception of the level of scavenger which was varied relative to the standard amount of the other ingredients. The resulting alkoxy end-capped polydiorganosiloxane polymer/VTM/MTM end product from the end-capping process was fed directly to an entry port in a first zone (zone 1) of the twin-screw extruder. Sealant cure catalyst (Dibutyltin dilaurate (DBTDL)) and adhesion promoter 3-(2-Aminoethyl) aminopropyltrimethoxysilane were also introduced into the twin-screw extruder through entry ports in said Zone 1 and the three components were mixed. The catalyst was introduced at a rate of 0.18 parts by weight per 100 parts by weight of resulting alkoxy end-capped polydiorganosiloxane polymer/VTM/MTM end product and the adhesion promoter was introduced at a rate of 1.23 parts by weight per 100 parts by weight of resulting alkoxy end-capped polydiorganosiloxane polymer/VTM/MTM end product.

The resulting mixture is transported into a second zone (zone 2) where the filler is introduced into the twin-screw extruder through a further entry port. The filler was introduced at a rate of 7.59 parts by weight per 100 parts by weight of resulting alkoxy end-capped polydiorganosiloxane polymer/VTM/MTM end product and resulting combination was further mixed to produce a filled mixture.

Given the DBTDL catalyst is present in the mixture prior to the introduction of the filler it is able to catalyse interactions between the cross-linker and the —OH groups on the silica surface, resulting in a hydrophobic treatment of the filler and the generation of alcoholic byproducts of the condensation reaction taking place.

The filled mixture was then transported downstream to a third zone (zone 3)containing a vent to the atmosphere and then into a fourth zone (zone 4) which functions as a devolatilizing zone. Table 1 provides the temperature of the material at the time of devolatilisation (Devol. temp (° C.)) was varied between 40° C. and 100° C. as shown in Table 1 below and the level of vacuum used was varied between 0-29″ Hg i.e. between 0.101 MPa (atmospheric pressure (no vacuum) and 0.003 MPa (almost full vacuum).

Subsequent to devolatisation of step (iii) and optional step (iv) the devolatised mixture enters a final, sixth zone in step (v) in which an alcohol scavenger is introduced.

The variables used in Ex.1 to 16 are depicted in Table 1 below. The amount of scavenger used is provided in parts by weight per 100 parts by weight of resulting alkoxy end-capped polydiorganosiloxane polymer/VTM/MTM end product as it was thought to be the best way to depict the variation in stabilizer level.

TABLE 1
stabilizer content, Devolatisation temps (° C.) and
vacuum applied on twin-screw extruder

| Sample | Devol. temp (° C.) | vacuum (MPa) | Stabilizer |
|---|---|---|---|
| 1 | 48 | 0.101 | 0.00 |
| | | (atmospheric | |
| | | pressure) | |
| 2 | 43 | 0.101 | 0.93 |
| 3 | 43 | 0.101 | 1.84 |
| 4 | 44 | 0.101 | 2.79 |
| 5 | 44 | 0.003 | 0.93 |
| 6 | 44 | 0.003 | 1.84 |
| 7 | 44 | 0.003 | 2.79 |
| 8 | 76 | 0.054 | 0.93 |
| 9 | 74 | 0.054 | 1.84 |
| 10 | 75 | 0.054 | 2.79 |
| 11 | 110 | 0.101 | 0.93 |
| 12 | 110 | 0.101 | 1.84 |
| 13 | 110 | 0.101 | 2.79 |
| 14 | 110 | 0.003 | 0.93 |
| 15 | 110 | 0.003 | 1.84 |
| 16 | 110 | 0.003 | 2.79 |

Samples prepared following the process described above were tested initially for Tack free time and durometer shore A after 7 days cure. Initial extrusion rate was measured in accordance with ASTM C1183-04. Tack free time (TFT) were measured in accordance with ASTM C679-15. Shore A durometer results were made in accordance with ASTM C661-15. Initial Tensile Strength and Elongation were measured in accordance with ASTM D412-98a(2002)e1.

TABLE 2
Initial physical property results

| | Initial | Initial | Initial | Initial 7 d | Initial 7 d |
|---|---|---|---|---|---|
| | extrusion rate | TFT | 7 d | Tens | Elong |
| Sample | (g/min) | (min) | Duro | (MPa) | (%) |
| 1 | 196 | 25 | 28 | 1.593 | 484 |
| 2 | 246 | 25 | 26 | 0.772 | 254 |
| 3 | 238 | 50 | 27 | 0.883 | 270 |
| 4 | 139 | 30 | 28 | 0.841 | 257 |
| 5 | 215 | 20 | 27 | 1.462 | 480 |
| 6 | 230 | 35 | 26 | 1.386 | 483 |
| 7 | 239 | 40 | 26 | 1.282 | 451 |
| 8 | 211 | 30 | 28 | 1.344 | 418 |
| 9 | 234 | 30 | 27 | 1.296 | 412 |
| 10 | 264 | 30 | 27 | 1.379 | 463 |
| 11 | 231 | 40 | 27 | 1.151 | 366 |
| 12 | 232 | 40 | 26 | 1.041 | 337 |
| 13 | 252 | 30 | 27 | 1.248 | 399 |
| 14 | 197 | 30 | 26 | 1.296 | 428 |
| 15 | 219 | 35 | 26 | 1.234 | 420 |
| 16 | 209 | 25 | 26 | 1.207 | 407 |

All of the samples after initial testing have acceptable and similar properties. Initially, they all cure well and have not experienced degradation that can occur over time.

Additional samples were similarly analysed 6 weeks aging at 50° C. The results are provided in Table 3 below.

TABLE 3
Physical Property results after aging for 6 weeks at 50° C.

| | TFT | 7 d | 7 d Tensile strength | 7 d Elong |
|---|---|---|---|---|
| Sample | (min) | Duro | (MPa) | (%) |
| 1 | uncured | uncured | Uncured | uncured |
| 2 | uncured | uncured | Uncured | uncured |
| 3 | >180 | 6 | 0.448 | 596 |
| 4 | 135 | 22 | 1.030 | 435 |
| 5 | uncured | uncured | Uncured | uncured |
| 6 | >180 | 22 | 1.443 | 629 |
| 7 | 140 | 20 | 1.273 | 573 |
| 8 | uncured | uncured | Uncured | uncured |
| 9 | 135 | 12 | 0.717 | 457 |
| 10 | >180 | 21 | 0.903 | 387 |
| 11 | uncured | uncured | Uncured | uncured |
| 12 | 155 | 9 | 0.375 | 419 |
| 13 | 95 | 23 | 1.101 | 439 |
| 14 | 90 | 22 | 1.289 | 554 |
| 15 | 75 | 20 | 1.112 | 484 |
| 16 | >180 | 21 | 1.154 | 533 |

When the examples are exposed to accelerated aging, stored, uncured at a temperature of 50° C., the differences in shelf stability are much more apparent. Examples that were processed at a cooler devolatilization temperature or with no or mid vacuum did not cure at all, especially when the amount of scavenger was low. Only samples with the high amount of scavenger cured at the low temperature and no/mid vacuum conditions. The shelf stability was improved as the devolatilization temperature increased and the pressure was reduced (stronger vacuum) as indicated by the samples curing well and retaining properties (there was less change in durometer between initial and after aging). At the higher temperature and stronger vacuum, less scavenger was needed to maintain shelf stability. The reason is that since the alcohol byproducts have had some time to form before the devolatilization zone, they are more efficiently removed as the temperature is increased and stronger vacuum is applied. Therefore, less scavenger is needed to chemically remove the alcohols to maintain shelf stability.

### Example 17

In this example an alternative catalyst was used to prepare the methoxy end-capped polydimethylsiloxane polymer in the pre-step making same using a static mixer and otherwise using the same process as described above but using the following composition:
(i) a dimethylsilanol terminated polydimethylsiloxane having a viscosity of 50,000 mPa·s at 25° C. and an average of 3.7 wt. % Si—OH groups per molecule in an amount of 97.00% by weight of the initial ingredients;
(ii) methyl trimethoxy silane (MTM) in an amount of 2.94% by weight of the initial ingredients;
(iii) 1,8-diazabicyclo[5.4.0]undec-7-ene (DBU) catalyst in an amount of 0.6% by weight of the initial ingredients.

The resulting alkoxy terminated siloxane polymer contained excess MTM after completion of the end-capping reaction. After completion the alkoxy end-capped polydiorganosiloxane polymer end-product was stored in a 50-gallon drum prior to use in the process described herein.

The one-part, silicone sealant composition was again prepared continuously in a twin-screw extruder. To zone 1 of the twin-screw extruder was added 100 parts by weight of the alkoxy terminated siloxane polymer (containing excess MTM) as well as 1.65 parts by weight of 3-(2-Aminoethyl)aminopropyltrimethoxysilane per 100 parts by weight of the Methoxy end-capped polydiorganosiloxane product and 0.33 parts by weight of Dibutyltin dilaurate (DBTDL) per 100 parts by weight of the Methoxy end-capped polydiorganosiloxane product. 8.78 parts by weight of fumed silica were introduced into the twin-screw extruder in zone 2. The temperature and pressure of the devolatilizing zone was 80° C. and 0.006 MPa respectively. The amount of scavenger (HMDZ) fed introduced in step (v), zone 6 was 1.37 parts by weight per 100 parts by weight of the Methoxy end-capped polydiorganosiloxane product.

Samples were tested initially for extrusion rate and tack free time. Durometer shore A, tensile strength, elongation, and modulus at 100% extension after 7 days cure using the test methodology identified above. The same tests were repeated on samples after four weeks of aging at 50° C. and the results are provided in Table 4 below.

TABLE 4
Ex. 17 Initial physical property results and results
after aging for 4 weeks at 50° C.

| | Initial | 4 weeks at 50° C. |
|---|---|---|
| extrusion rate (g/min) | 142 | 184 |
| tack free time (min) | 30 | 60 |
| durometer shore A | 29 | 23 |
| tensile strength (MPa) | 1.717 | 2.289 |
| elongation (%) | 533 | 862 |

### Example 18

In the following example the methoxy end-capped polydimethylsiloxane polymer was prepared in a static mixer using the same process as described above but using the following composition:
(i) a dimethylsilanol terminated polydimethylsiloxane having a viscosity of 50,000 mPa·s at 25° C. and an average of 3.7 wt. % Si—OH groups per molecule in an amount of 98.08% by weight of the initial ingredients;
(ii) vinyl trimethoxy silane (VTM) in an amount of 1.81% by weight of the initial ingredients;
(iii) a 2% solution of 1,5,7-Triazabicyclo[4.4.0]dec-5-ene (TBD) catalyst in MTM in an amount of 0.11% by weight of the initial ingredients.

It will be appreciated that there was a much smaller excess of VTM/MTM after reaction completion given far less MTM was used than in the above. Furthermore, in this instance the resulting methoxy end-capped polydimethylsiloxane polymer first non-continuous step and stored prior to use in the composition herein.

The one-part, silicone sealant composition was prepared as described above with slight variations, in that additional vinyl trimethoxy silane cross-linker was introduced direct into the twin-screw extruder and is utilised as cross-linker together with the excess of VTM/MTM from the alkoxy end-capped polydiorganosiloxane polymer end-product. The following ingredients (as depicted in Table 5) were introduced into the twin-screw extruder in zone 1.

TABLE 5
Ex. 18 ingredients were introduced into
the twin-screw extruder in zone 1.

| | Parts by | Weight % |
|---|---|---|
| | weight | (Wt. %) |
| Methoxy end-capped | 100 | 87.70 |
| polydiorganosiloxane product | | |
| alkoxy silane cross-linker (VTM) | 0.73 | 0.64 |
| Aminosilane 3-(2- | 1.58 | 1.39 |
| Aminoethyl)aminopropyltrimethoxysilane | | |
| 3-Glycidyloxypropyl)trimethoxysilane | 0.85 | 0.75 |
| Dioctyltin diacetate | 0.15 | 0.10 |

Parts by weight were as previously described i.e. parts by weight per 100 parts by weight of the Methoxy end-capped polydiorganosiloxane product. Weight % values provided are the Wt. % of each component with the final composition being 100 wt. %.

Other variations from the above comprised there being
(i) 9.04 parts by weight (7.94 wt. %) of the fumed silica as described above was introduced into the twin-screw extruder in zone 2;
(ii) the temperature and pressure of the devolatilizing zone was 80° C. and 0.013 MPa;
(iii) the amount of scavenger (HMDZ) fed to zone 6 in step (v) was 1.69 parts by weight (1.48 wt. %).

Again the composition prepared was analysed for its initial physical properties for extrusion rate and tack free time. Durometer shore A, tensile strength, elongation, were tested after 7 days cure using the methodology as described above.

TABLE 6
Ex. 18 Initial physical property results

| | |
|---|---|
| extrusion rate (g/min) | 138 |
| tack free time (min) | 15 |
| durometer shore A | 35 |
| tensile strength (MPa) | 1.662 |
| elongation (%) | 383 |

### Example 19

In this example there is provided a continuous process as described with Examples 1 to 16 with the main difference that subsequent to the end capping process, which was exactly the same as for Examples 1 to 16, half of the methoxy end-capped polydiorganosiloxane was introduced into the twin-screw extruder in zone 1 and the remaining half of the methoxy end-capped polydiorganosiloxane was introduced into the twin-screw extruder in zone 4 prior to the devolatisation step (v).

The other components introduced into the twin-screw extruder in zone 1 were 1.23 parts by weight of Aminosilane 3-(2-Aminoethyl)aminopropyltrimethoxysilane per 100 parts by weight of the methoxy end-capped polydiorganosiloxane product and 0.18 parts by weight of Dibutyltin dilaurate (DBTDL) per 100 parts by weight of the methoxy end-capped polydiorganosiloxane product. 11.16 parts of fumed silica were introduced into the twin-screw extruder in zone 2. The temperature and pressure of the devolatilizing zone was 80° C. and 0.013 MPa respectively. The amount of scavenger (HMDZ) fed to zone 6 during step (v) was 2.46 parts by weight per 100 parts by weight of the Methoxy end-capped polydiorganosiloxane product.

Samples were tested initially for extrusion rate and tack free time. Durometer shore A, tensile strength, elongation, and modulus at 100% extension after 7 days cure.

TABLE 7
Ex. 19 Initial physical property results

| | |
|---|---|
| extrusion rate (g/min) | 131 |
| tack free time (min) | 30 |
| durometer shore A | 27 |
| tensile strength (MPa) | 1.172 |
| elongation (%) | 368 |

It can be seen from the examples that we are using untreated silica whereas in the past treated silica has been preferred for such processes. Treated silica requires much less scavenger, since there is less OH on the silica. We are able to use untreated silica, which has a cost benefit whilst still using low amounts of scavenger by using process conditions as described herein as much of the alcoholic byproducts are removed from the composition prior to introduction of the scavenger resulting in significantly less scavenger being required than would historically have been for untreated silica processes because the alcohol is removed early, i.e. before the introduction of scavenger.

1. A process for the preparation of a one-part, silicone sealant composition, the method comprising the steps of:
(i) introducing an alkoxy end-capped polydiorganosiloxane polymer, a tin-based catalyst, a cross-linker, and optionally one or more adhesion promoters in a mixer and mixing;
(ii) adding one or more reinforcing and optionally non-reinforcing fillers into the mixer and mixing so that residual chemically available —OH groups on the polymer and/or filler are able to undergo a condensation reaction with the cross-linker and/or optional adhesion promoter to generate alcohol byproducts;
(iii) applying a vacuum to remove the alcoholic byproducts at a temperature of between 50° C. and 100° C.;
(iv) optionally cooling the resulting composition; and
(v) introducing an alcohol scavenger in an amount of from 0.5-3.0 wt. % of the composition.

2. The process for the preparation of a one-part, silicone sealant composition in accordance with claim 1, wherein the filler is hydrophobically treated in-situ.

3. The process for the preparation of a one-part, silicone sealant composition in accordance with claim 1, wherein the filler comprises fumed silica, precipitated silica or calcium carbonate or a mixture thereof.

4. The process for the preparation of a one-part, silicone sealant composition in accordance with claim 1, wherein the vacuum used in step (iii) is between 0.54 MPa and 0.003 MPa.

5. The process for the preparation of a one-part, silicone sealant composition in accordance with claim 1, wherein the process is a continuous process and the mixer is a twin-screw extruder.

6. The process for the preparation of a one-part, silicone sealant composition in accordance with claim 5, wherein the alkoxy end-capped polydiorganosiloxane polymer is prepared in a pre-step by end-capping a silanol terminated polydiorganosiloxane with a polyalkoxy silane in the presence of a catalyst.

7. The process for the preparation of a one-part, silicone sealant composition in accordance with claim 6, wherein the catalyst consists of one or more linear, branched or cyclic molecules comprising at least one amidine group, guanidine group, or derivatives of the amidine group and/or guanidine group or a mixture thereof in an amount of from 0.0005 to 0.75 wt. % of the starting materials composition.

8. The process for the preparation of a one-part, silicone sealant composition in accordance with claim 6, wherein the polyalkoxy silane is provided in the initial step in excess such that the unreacted polyalkoxy silane remaining after preparation of the alkoxy end-capped polydiorganosiloxane polymer is utilised as at least a portion of the cross-linker for the one-part silicone sealant composition.

9. The process for the preparation of a one-part, silicone sealant composition in accordance with claim 1, wherein part of the alkoxy end-capped polydiorganosiloxane polymer is added after the introduction of the filler but before step (iii).

10. The process for the preparation of a one-part, silicone sealant composition in accordance with claim 5, wherein the one-part, silicone sealant composition exits from the twin-screw extruder and is transported to a packaging unit for packaging and storage.

11. The process for the preparation of a one-part, silicone sealant composition in accordance with claim 1, wherein the alcohol scavenger is a silazane.

12. A one-part, silicone sealant composition obtainable or obtained from the process of claim 1.

13. The one-part, silicone sealant composition in accordance with claim 12, comprising:
(a) an alkoxy terminated polydiorganosiloxane;
(b) reinforcing filler;
(c) cross-linker;
(d) a tin-based cure catalyst; and
optionally
(e) adhesion promoter.

14. The one-part, silicone sealant composition in accordance with claim 12, which is gunnable and/or self-levelling.

15. The one-part, silicone sealant composition in accordance with claim 12, capable of being applied as a paste to a joint between two adjacent substrate surfaces where it can be worked, prior to curing, to provide a smooth surfaced mass which will remain in its allotted position until it has cured into an elastomeric body adherent to the adjacent substrate surfaces.

16. A silicone elastomer which is the reaction product obtained by curing the one-part sealant composition in accordance with claim 12.

17. The one-part, silicone sealant composition in accordance with claim 12, as a sealant in at least one of the facade, insulated glass, window construction, automotive, solar and construction fields.

18. A method for filling a space between two substrates so as to create a seal therebetween, the method comprising:
providing the one-part, silicone sealant composition in accordance with claim 12, and either;
applying the silicone sealant composition to a first substrate, and bringing a second substrate in contact with the silicone sealant composition that has been applied to the first substrate; or
filling a space formed by the arrangement of a first substrate and a second substrate with the silicone sealant composition and curing the silicone sealant composition.

19. The method for filling a space between two substrates in accordance with claim 18, wherein the space is filled by introducing the silicone sealant composition by way of extrusion or through a sealant gun.
